(19) United States
(12) Patent Application Publication
(10) Pub. No.: US 2009/0040186 A1
(43) Pub. Date: Feb. 12, 2009

(54) Method and System for Displaying Multiple Synchronized Images

(76) Inventor: Alan W. Esenther, Ashland, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/835,068

(22) Filed: Aug. 7, 2007

(51) Int. Cl. G06F 3/041

(52) U.S. Cl. 345/173

(57) ABSTRACT

A primary image is displayed a touch sensitive surface while touches at a first location and a second location on the touch sensitive surface are sensed. A baseline between the first location and the second location is determined. The baseline has a length and orientation. A secondary image comparable to the primary image is displayed. The secondary image has a size and a point of view corresponding respectively to the length and orientation of the baseline. Multiple users can also interact with the primary image simultaneously.

### FIELD OF THE INVENTION

This invention relates generally to graphical user interfaces, and more particularly to displaying multiple synchronized images.

### BACKGROUND OF THE INVENTION

Graphical user interfaces such as Google Earth and Microsoft Virtual Earth provide users with interactive maps and other geographic imagery. One drawback is that those interfaces only present a single view at a time. On a 2D map, a user can select a street map, a satellite view, or a hybrid combination of the two. On a 3D map, the user can specify layers such roads, political borders, and other content. Different views of the same map can look different depending on the content that is displayed.

Generating multiple layers on the same map becomes cumbersome and some information can become obscured or difficult to visualize. Separating different views into different synchronized images is one solution. If 2D and 3D views are synchronized, then the views are so different that separating them becomes even more of a necessity. Typically, the primary view is 2D, and secondary views can be 2D or 3D.

### SUMMARY OF THE INVENTION

The embodiments of the invention provide a method for displaying multiple synchronized images. In one embodiment, the images are maps or other geography imagery, such as satellite and aerial photography.

A primary image is displayed on a touch sensitive surface while touches at a first location and a second location on the touch sensitive surface are sensed. A baseline between the first location and the second location is determined. The baseline has a length and orientation. A secondary image comparable to the primary image is displayed. The secondary image has a size and a point of view corresponding respectively to the length and orientation of the baseline.

In contrast with conventional interactive maps, the multi-touch gestures do not affect the primary view with which the user is directly interacting. The primary view is static during the touching. Instead, the secondary image is manipulated. The novelty of the enhancement is the combination of the fact that the bimanual gestures only effect the secondary view, and that the rotation, location and zoom factor of the secondary view can all be controlled simultaneously with simple hand gestures.

The ease of concurrently panning, zooming and rotating a secondary map view greatly improve the end user's ability to explore maps. The system is designed such that there can be multiple simultaneous 2D or 3D secondary images.

### BRIEF DESCRIPTION OF THE DRAWINGS

FIG. 1 is a display of multiple images according to an embodiment of the invention;

FIG. 2 is a block diagram of a system for displaying multiple images according to the an embodiment of the invention;

FIG. 3 is a flow diagram of a method for displaying images according to an embodiment of the invention;

FIG. 4 is a schematic comparing touched locations according to embodiments of the invention to mouse based navigation controls.

### DETAILED DESCRIPTION OF THE PREFERRED EMBODIMENTS

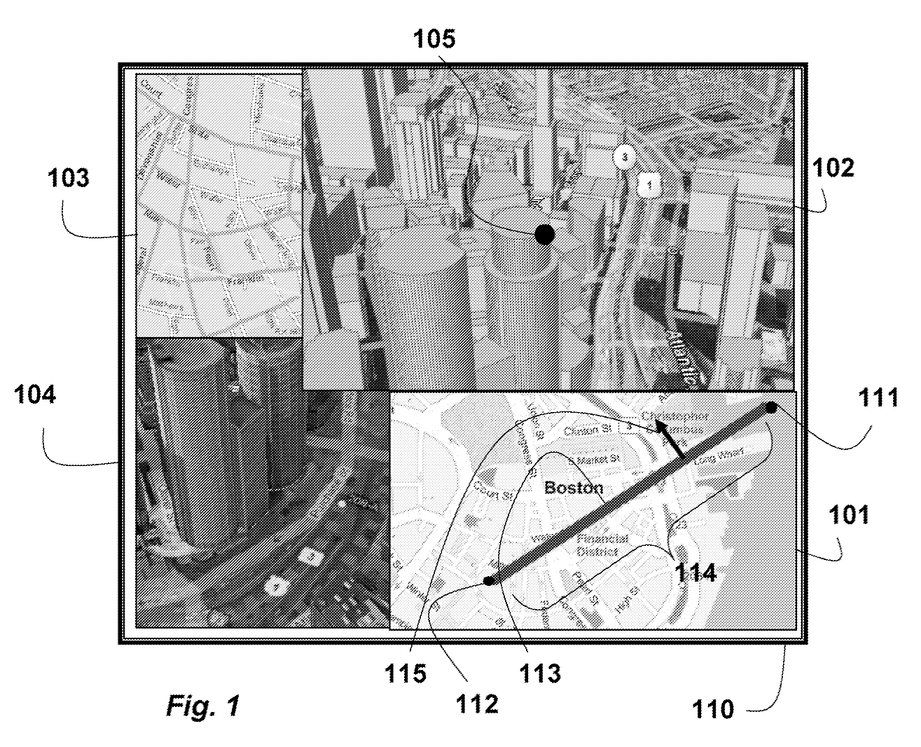

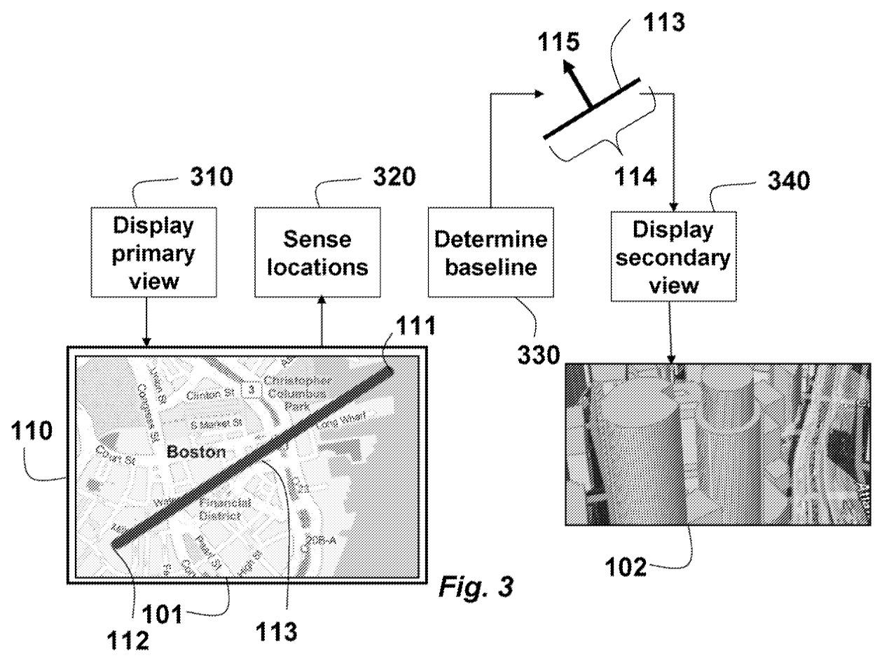

FIGS. 1-3 shows a method and a system for displaying multiple synchronized images. A primary image 101 is displayed 310 on a touch sensitive surface 310. Touches at a first location 111 and a second location 112 on the touch sensitive surface are sensed 320 while displaying the primary image. A baseline 113 is determined 330 between the first location and the second location. The baseline 113 has a length 114 and an orientation 115. A secondary image 102 comparable to the primary image is displayed 340 synchronously while sensing the locations. A size and point of view of the secondary image correspond respectively to the length and orientation of the baseline. The center 105 of the secondary image corresponds to the center of the baseline 113.

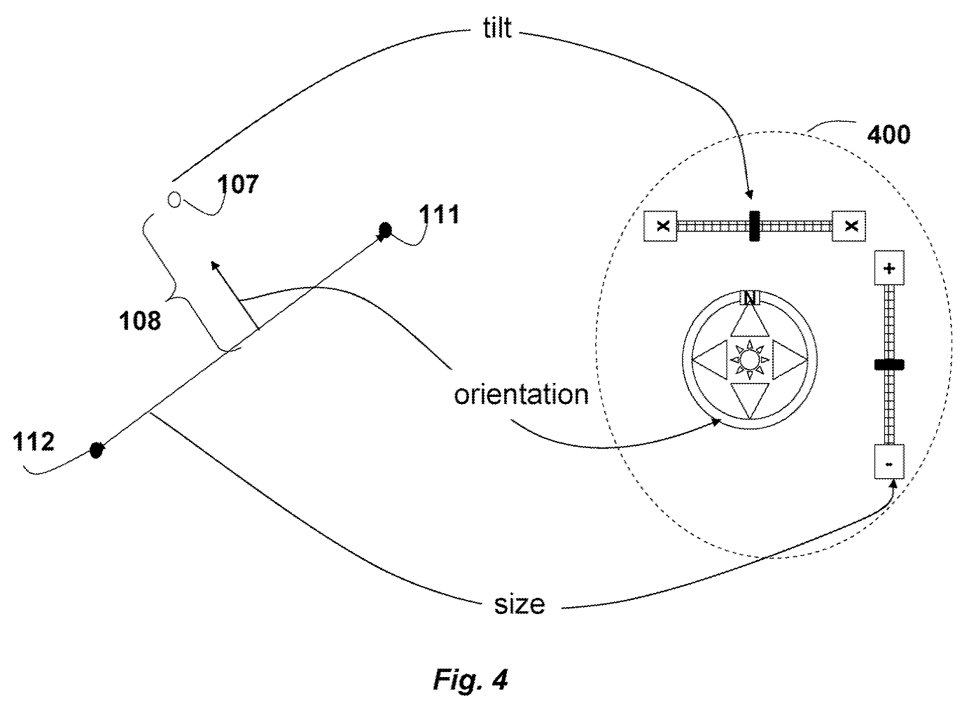

As shown in FIG. 4, a touching of a third location 107 can be used to control the azimuth angle or ‘tilt’ of the secondary view. For example, if the third location is close to the baseline, then the point of view is at a right angle with respect to the plane of the primary image. If the distance is large, the view is substantially horizontal. FIG. 4 also shows the relationship between the touched locations according to the invention and mouse based navigation controls 400. However, it should be noted that touching of the primary image does not change the appearance of the primary image apart from overlaying the baseline 113. This is in contrast with conventional interactive map display, where mouse commands change the appearance of the primary image.

As shown in FIG. 1, multiple secondary images can be displayed concurrently. The primary image 101 is usually static during the multi-touch interactions, e.g., a top view 2D street map, geographic map or satellite image. Image 102 is a 3D view of buildings located on a street map. Image 103 is a detailed, large size, 2D street map. Image 104 is a 3D satellite image. In one embodiment of the invention, all images are displayed on the touch sensitive surface. However, the comparable images can be displayed elsewhere, such as vertically arranged display surfaces.

In one embodiment, the touch sensitive surface can distinguish multiple simultaneous touches by multiple users, and uniquely associate individual touches with particular users. This enables multiple users to interact concurrently with the primary image while displaying different secondary images for each user.

A user interacts with the primary view 101, which is usually static during the multi-touch interactions. The user touches the primary view at two locations 111 and 112. The two locations determine the baseline 113. The size and point of view in the secondary images correspond to the length and orientation of the baseline 113. For example, a large length indicates a close up view, while a small length indicates distant view. The secondary image 105 is centered on the center of the baseline. Moving both touched locations at the same time results in panning and or scaling.

It can be understood that the orientation of the baseline is reversible about 180 degrees. Therefore, an order in which the two locations are initially touched is used to resolve the orientation of the view or baseline, as indicated by the arrow 115. In this example, the orientation is generally “up” or north. For example, if the right location was touched first by a finger on the right hand, then the point of view is north. If the user intends to look south, then the user touches the left location first. Significantly, this works even if the hands are crossed such that the left finger touches a location, which turns out to be the right of the other touch location. This is true because the touch surface can uniquely identify the touches. It should be understood that other orders of touching conventions could also be used.

Rotating one finger around the other caused the point of view to rotate or pan about the pivot location, i.e., the center of the baseline. Doing these touching gestures at the same time is natural, and can be performed without the user needing to look at the primary image, while interactively manipulating the secondary view.

Using this technique, the user can select a neighborhood, and view the neighborhood from above, then zoom down to see the view when looking down a particular street, and then reverse the view to see the view when looking down the street in the opposite direction. These gestures can be performed much more quickly and naturally than using conventional mouse and keyboard interactions.

Information about the latitude, longitude, rotation and zoom factor indicated by the two touches, along with other information helpful for cross-application integration, is passed to a web service. Typically, the application in the primary view uses the web service to update the views accordingly.

One or more client applications can poll a web based server application for changes. Because client applications can consume a web service as easily as a web application, basing the system on a web server insured that a wide variety of client applications can be synchronized.

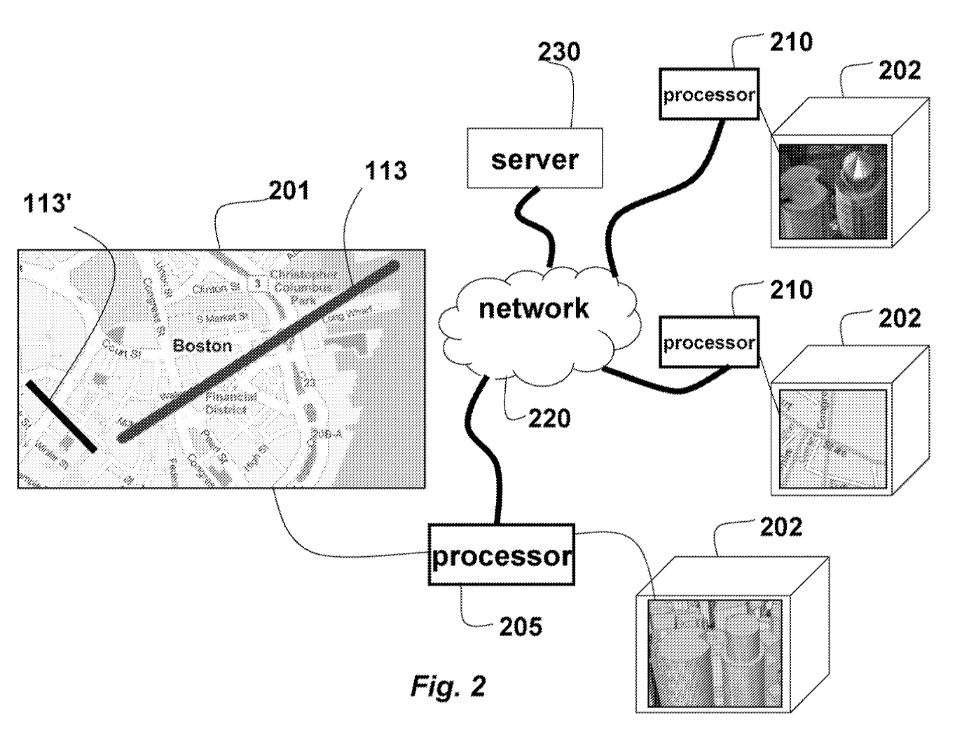

FIG. 2 shows a tabletop touch sensitive display unit 201 connected to a processor 205 for running an application that displays the primary image. The processor also updates an application on the server 230. The processor can be connected to a network 220 to access the server application. The server application is updated with information about each user's baseline 113 from the processor 205 attached directly to the touch-sensitive display 201. Client applications running on the local processor 205 or remote processors 210 fetch information about the baselines to generate the secondary views 202.

Multiple simultaneous users can also be accommodated. For example, two users can each concurrently control independent and separate secondary view by simultaneously touching the primary image at different locations. Each user is associated with their own baseline 113-113′. Of course in this mode, it is essential that the primary image remains static. The baselines can be shown in different colors. This simultaneous user mode is not possible with conventional touch sensitive display surfaces.

Rather than showing another a similar image, the secondary display can show alternative information, for example, a secondary view can show a bar chart of population by age for a particular region that is dynamically specified.

Applications that are unrelated to maps can also be implemented. For example, an interactive information visualization system can allow users to select regions of a spreadsheet and display dynamic bar and radial charts of the selected regions in two secondary views. In addition to controlling the locations, angle and zoom factor, we can also control the azimuth angle or tilt, and add or remove layers from all views or from a particular view, such as roads, buildings, landmarks, political boundaries, water, navigational aids, and the like.

### Effect of the Invention

The invention provides a method for changing a point of view of a secondary displayed image by touching a primary displayed image. The system includes a touch sensitive surface that can distinguish multiple simultaneous touches.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for displaying images, comprising:
displaying a primary image on a touch sensitive surface;
sensing touches at a first location and a second location on the touch sensitive surface while displaying the primary image;
determining a baseline between the first location and the second location, the baseline having a length and orientation; and
displaying a secondary image comparable to the primary image, in which a size and a point of view of the secondary image correspond respectively to the length and orientation of the baseline.

2. The method of claim 1, further comprising:
sensing the touches while the first and second locations change;
displaying the secondary image while the first and second locations change.

3. The method of claim 1, in which a center of the secondary image corresponds to a center of the baseline.

4. The method of claim 1, further comprising;
sensing a touching at a third location;
determining a distance between the third location and the baseline; and
displaying the secondary image, in which a tilt of the secondary image corresponds to the distance.

5. The method of claim 1, in which multiple users touch the touch sensitive surface while displaying the primary image, and further comprising:
identifying uniquely the touches with the multiple users;
determining the base line for each user; and
displaying a different secondary image for each user corresponding the baseline associated with each users.

6. The method of claim 1, in which the secondary image is displayed on a different display surface than the touch sensitive surface.

7. The method of claim 1, in which the primary image is static.

8. The method of claim 1, in which an order of initially touching the first and second locations resolve the orientation of the baseline.

9. The method of claim 1, further comprising:
overlaying information related to the primary image on the secondary image.

10. The method of claim 1, in which the primary and secondary images display geographic information.

11. The method of claim 5, in which the primary image remains static while displaying the different secondary image.

12. The method of claim 5, in which each secondary image is displayed on a different display surfaces.

13. A system for displaying images, comprising:
a touch sensitive surface;
means for displaying a primary image on the touch sensitive surface;
means for sensing touches at a first location and a second location on the touch sensitive surface while displaying the primary image;
means for determining a baseline between the first location and the second location, the baseline having a length and orientation; and
means for displaying a secondary image comparable to the primary image, in which a size and a point of view of the secondary image correspond respectively to the length and orientation of the baseline.
